(19) United States
(12) Patent Application Publication
(10) Pub. No.: US 2014/0209696 A1
(43) Pub. Date: Jul. 31, 2014

(54) INDOOR CLIMATE CONTROL SYSTEM

(71) Applicant: EDUARD MAZANEC, NEWARK, CA (US)

(72) Inventor: EDUARD MAZANEC, NEWARK, CA (US)

(21) Appl. No.: 14/166,702

(22) Filed: Jan. 28, 2014

Related U.S. Application Data
(60) Provisional application No. 61/757,828, filed on Jan. 29, 2013.

(51) Int. Cl. F24F 11/00; G05D 23/19

(52) U.S. Cl. CPC F24F 11/0086; G05D 23/1919
USPC 236/1 B; 236/51

(57) ABSTRACT

An indoor climate control system is configured to adjust a first temperature of a first room within a structure. The indoor climate control system has a receiver mechanically coupled to an HVAC unit configured to turn the HVAC unit on and off. A portable wireless thermostat communicatively coupled to the receiver. The portable wireless thermostat transmits a desired climate information to the receiver which then engages the HVAC unit to adjust the first temperature of the first room.

### RELATED APPLICATION

This application claims priority to provisional patent application U.S. Ser. No. 61/757,828 filed on Jan. 29, 2013, the entire contents of which is herein incorporated by reference.

### BACKGROUND

The embodiments herein relate generally to devices that control the climate of an indoor space.

Prior to embodiments of the disclosed invention, there was no integrated system of using a moving thermostat in order to change the temperature in a particular portion inside of a structure. For instance, the Venstar Wireless Thermostat System has a theory of how to move a thermostat around a house, but the entire house (or up to two zones) would have to be heated or cooled together. This is inefficient. Likewise, U.S. Pat. No. 7,062,830 teaches a plurality of “wireless thermometers in each room,” but lacks the ability to Figure out where a maneuverable thermostat is and has no theory of how that can work to control temperature in a portion of a home. Embodiments of the present invention solve this problem.

### SUMMARY

An indoor climate control system is configured to adjust a first temperature of a first room within a structure. The indoor climate control system has a receiver mechanically coupled to an HVAC unit configured to turn the HVAC unit on and off. A portable wireless thermostat communicatively coupled to the receiver. The portable wireless thermostat transmits a desired climate information to the receiver which then engages the HVAC unit to adjust the first temperature of the first room.

In some embodiments, a stationary thermostat can be communicatively coupled to the receiver. The portable wireless thermostat transmits a second desired climate information to the receiver which then engages the HVAC unit to adjust a second temperature in a second room. In some embodiments, the portable wireless thermostat can be further communicatively coupled to the stationary thermostat to adjust the second desired climate information to adjust the second temperature in the second room

In some embodiments, the portable wireless thermostat further comprises a positioning circuit to determine a location of the portable wireless thermostat. The location is communicated to the receiver. The receiver communicates a default temperature to the portable wireless thermostat. The portable wireless thermostat can further include a display screen configured to display the default temperature. The portable wireless thermostat can further include adjustment arrows configured to adjust the default temperature. The portable wireless thermostat can further include a solar cell configured to recharge batteries within the portable wireless thermostat.

### BRIEF DESCRIPTION OF THE FIGURES

The detailed description of some embodiments of the invention is made below with reference to the accompanying Figures, wherein like numerals represent corresponding parts of the Figures.

FIG. 1 is a perspective view of an embodiment of the invention.

FIG. 2 is a perspective view of a stationary thermostat with wireless capability as shown in the system of FIG. 1.

FIG. 3 is a perspective view of a portable wireless thermostat as shown in the system of FIG. 1.

FIG. 4 is schematic view of the system of FIG. 1.

FIG. 5 is a flowchart of the system of FIG. 1.

### DETAILED DESCRIPTION OF CERTAIN EMBODIMENTS

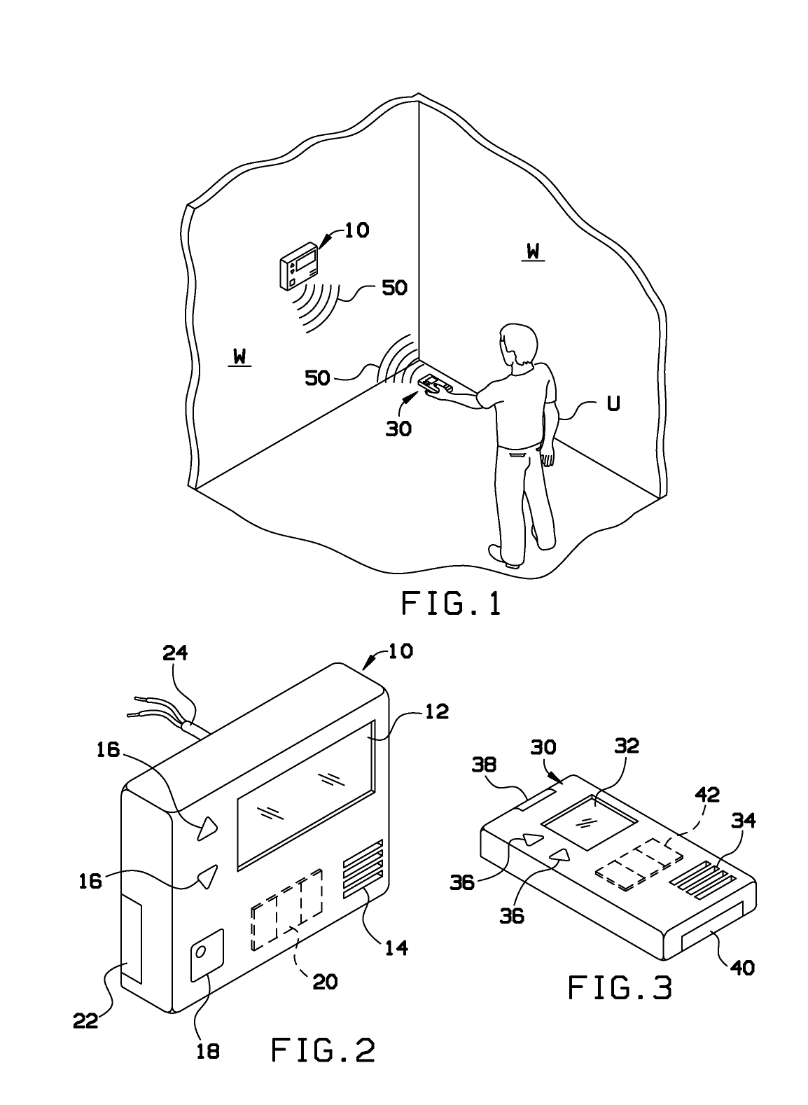

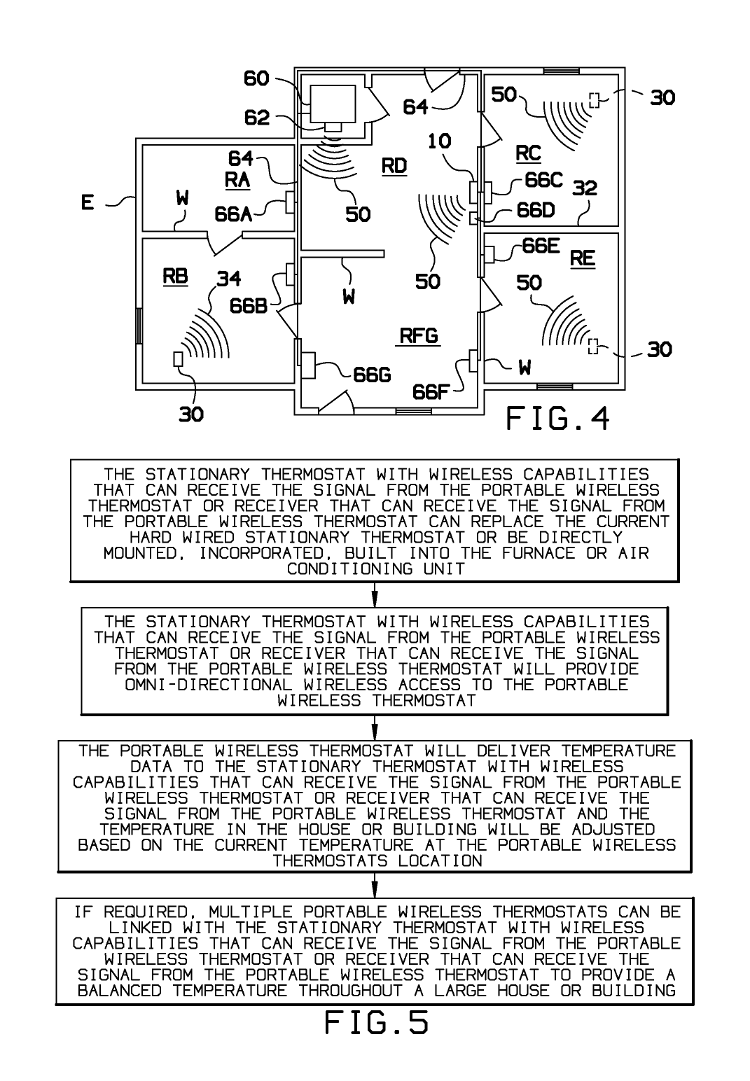

By way of example, and referring to FIG. 1, user U wants to control the climate in a space defined, at least in part by walls W. User U can do this by manually adjusting stationary thermostat 10. Stationary thermostat 10 communicates with wireless signal 50 to climate control receiver 62 as shown in FIG. 4 below. Alternately, User U can manually adjust portable wireless thermostat 30 with wireless signal 50 to climate control receiver 62 as shown in FIG. 4 below.

Turning to FIG. 2, stationary thermostat 10 comprises screen 12. In some embodiments, screen 12 can be a liquid crystal display (LCD), a light emitting diode (LED) display, an active-matrix organic light-emitting diode (AMOLED) display, or an organic light-emitting diode (OLED) display, among others. Stationary thermostat 10 further comprises thermocouple 14 that determines the ambient temperature proximate stationary thermostat 10. Stationary thermostat further comprises a processor to adjust the ambient temperature that can be adjusted with adjustment arrows 16. In some embodiments, stationary thermostat 10 can send and receive wireless signals with wireless transmitter/receiver 18. In other embodiments, stationary thermostat 10 can be wired directly to HVAC unit 60 as shown in FIG. 4 below.

Stationary thermostat 10 comprises power unit 20. In some embodiments, power unit 20 can be one or more of a battery, solar panel or fuel cell. When batteries are used, they can be stored in battery compartment 22.

FIG. 3 shows portable wireless thermostat 30. Portable wireless thermostat 30 comprises portable screen 32. In some embodiments, portable screen 32 can be a liquid crystal display (LCD), a light emitting diode (LED) display, an active-matrix organic light-emitting diode (AMOLED) display, or an organic light-emitting diode (OLED) display, among others. Portable wireless thermostat 30 further comprises portable thermocouple 34 that determines the ambient temperature proximate portable wireless thermostat 30. Portable wireless thermostat 30 further comprises a processor and a positioning circuit to adjust the ambient temperature proximate portable wireless thermostat 30 that can be adjusted with portable adjustment arrows 36. In some embodiments, portable wireless thermostat 30 can send and receive wireless signals with wireless transmitter/receiver 38.

Portable wireless thermostat 30 comprises portable power unit 40. In some embodiments, portable power unit 40 can be one or more of a battery, solar panel or fuel cell. When batteries are used, they can be stored in portable battery compartment 42.

In an improvement over the systems of in Venstar or the '830 patent, portable wireless thermostat 30 has a positioning circuit that contains one or more of radio frequency (RF), WiFi, GPRS, and global positioning service (GPS) location tracking functionality. Of these a 433/916 MHz radio frequency radio frequency identification (RFID) circuit has been shown to be effective because, there are few home electronics operating on that frequency. Of course, 2.4 GHz can also be used effectively, but there are more devices operating on that higher frequency.

Applying this technology to a typical indoor structure is shown in FIG. 4. In FIG. 4, The structure is defined by exterior walls E and interior walls W where the Exterior and interior walls are configured to, in this case, form seven rooms, of which six (labeled R) are heated and cooled. A central heating ventilation and air conditioning (HVAC) system is shown, but the system could be easily applied to an alternate configuration with a series of HVAC units in each room.

HVAC unit 60 is electrically coupled to receiver 62. Receiver 62 can be a unit substantially identical to stationary thermostat 10, but receiver 62 has the ability to both send and receive temperature information from a plurality of locations around the indoor structure. Much like the '830 patent, HVAC unit 60 is mechanically coupled to ducting 64 that travels to each room R. Here ducting 64 is mechanically coupled to first vent 66A, second vent 66B, third vent 66C, fourth vent 66D, fifth vent 66E, sixth vent 66F and seventh vent 66G.

First vent 66A has an open configuration and a closed configuration that can be electronically adjusted by a first actuator communicatively coupled to receiver 62. First vent 66A provides conditioned air to first room RA.

Likewise, second vent 66B has an open configuration and a closed configuration that can be electronically adjusted by a second actuator communicatively coupled to receiver 62. Second vent 66B provides conditioned air to second room RB.

Similarly, third vent 66C has an open configuration and a closed configuration that can be electronically adjusted by a third actuator communicatively coupled to receiver 62. Third vent 66C provides conditioned air to third room RC.

In a similar manner, fourth vent 66D has an open configuration and a closed configuration that can be electronically adjusted by a fourth actuator communicatively coupled to receiver 62. Fourth vent 66D provides conditioned air to fourth room RD.

Likewise, fifth vent 66E has an open configuration and a closed configuration that can be electronically adjusted by a fourth actuator communicatively coupled to receiver 62. Fourth vent 66C provides conditioned air to fourth room RD.

Both sixth vent 66F and seventh vent 66G have an open configuration and a closed configuration that can be electronically adjusted by a sixth actuator and a seventh actuator communicatively coupled to receiver 62. Both sixth vent 66F and seventh vent 66G provide conditioned air to sixth room RFG.

As user U moves from second room RB to sixth room RFG, the climate in second room RB will return to a default that exists if no one is in the room. User U can change this setting with stationary thermostat 10, portable wireless thermostat 30 or receiver 62. In this regard, User U can program a default temperature with and without occupants around the structure, along with temperatures that are changed by portable wireless thermostat 30.

FIG. 5 provides a flow chart showing another mode of operation. Stationary thermostat 10 can communicate signals 50 with portable wireless thermostat 30. Receiver 62 must be mechanically coupled to HVAC unit 60, but stationary thermostat 10 can be either communicatively coupled to receiver 62 with or without wires. Stationary thermostat 10 can provide omni-directional wireless access to portable wireless thermostat 30.

Both the portable wireless thermostat 30 and the stationary thermostat 10 send temperature information to receiver 62. That information can be used to adjust the temperature in a room R. In some embodiments, a plurality of portable wireless thermostats 30 can be used to adjust the temperature in several rooms R in different directions at different times.

Persons of ordinary skill in the art may appreciate that numerous design configurations may be possible to enjoy the functional benefits of the inventive systems. Thus, given the wide variety of configurations and arrangements of embodiments of the present invention the scope of the invention is reflected by the breadth of the claims below rather than narrowed by the embodiments described above.

What is claimed is:

1. An indoor climate control system configured to adjust a first temperature of a first room within a structure; the indoor climate control system:
a receiver mechanically coupled to an HVAC unit configured to turn the HVAC unit on and off;
a portable wireless thermostat communicatively coupled to the receiver; wherein the portable wireless thermostat transmits a desired climate information to the receiver which then engages the HVAC unit to adjust the first temperature of the first room.

2. The indoor climate control system of claim 1, further comprising:
a stationary thermostat communicatively coupled to the receiver; wherein the portable wireless thermostat transmits a second desired climate information to the receiver which then engages the HVAC unit to adjust a second temperature in a second room.

3. The indoor climate control system of claim 2, wherein the portable wireless thermostat is further communicatively coupled to the stationary thermostat to adjust the second desired climate information to adjust the second temperature in the second room.

4. The indoor climate control system of claim 3, wherein the portable wireless thermostat further comprises a positioning circuit to determine a location of the portable wireless thermostat; wherein the location is communicated to the receiver; wherein the receiver communicates a default temperature to the portable wireless thermostat.

5. The indoor climate control system of claim 4, wherein the positioning circuit is a 433/916 MHz radio frequency radio frequency identification circuit in order to avoid interfering with other electronic equipment in the structure.

6. The indoor climate control system of claim 4, wherein the portable wireless thermostat further comprises a display screen configured to display the default temperature.

7. The indoor climate control system of claim 5, wherein the portable wireless thermostat further comprises adjustment arrows configured to adjust the default temperature.

8. The indoor climate control system of claim 3, wherein the portable wireless thermostat further comprises a solar cell configured to recharge batteries within the portable wireless thermostat.
